(19) United States
(12) Patent Application Publication
(10) Pub. No.: US 2008/0194736 A1
(43) Pub. Date: Aug. 14, 2008

(54) PVC nanocomposite manufacturing technology and applications

(76) Inventor: Minqiu Lu, Port Lavaca, TX (US)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(21) Appl. No.: 11/706,048

(22) Filed: Feb. 13, 2007

(51) Int. Cl. C08L 27/06; C08K 3/00; C08K 3/32; C08K 3/36; C08L 1/00

(52) U.S. Cl. 524/35; 524/1; 524/403; 524/409; 524/413; 524/414; 524/425; 524/432; 524/433; 524/437; 524/440; 524/445; 524/447; 524/449; 524/450; 524/451; 524/493; 524/496

(57) ABSTRACT

The present invention relates to a process and a product of forming polymer (especially PVC) nanocomposites with a variety of nanofillers. The present invention provides a method for forming a polymer nanocomposite, comprising powder mixing a composition comprising polymer resin, a nanofiller, and a coupling agent for a residence time of about 4 to about 8 minutes to form a dry blend and extruding the dry blend in an extrusion process. Additionally, the present invention relates to a polymer nanocomposite formed by a process, comprising powder mixing a polymer resin, a nanofiller, and a coupling agent for a residence time of about 4 to about 8 minutes to form a dry blend and extruding the dry blend in an extrusion process to achieve homogeneous dispersion of nanofillers in the polymer matrix.

### FIELD OF THE INVENTION

The present invention relates to polymer nanocomposites, their manufacturing methodology and technology, and their applications in a variety of markets as replacement materials with much better performance to cost ratio.

### BACKGROUND OF THE INVENTION

Polymer composites have been produced for decades by adding minerals fillers into thermoplastics and thermosets. Depending on applications, polymer composites can be tailored to improve a number of desired properties, such as heat distortion temperature and modulus. However, other properties, such as strength, impact resistance, gloss, and lightweight properties, may be sacrificed. These conventional fillers have been successfully used to decrease costs of polymer composites.

Recently, there has been enormous interest in polymer nanocomposites because of their low cost and high performance potential for an unlimited spectrum of applications in automotive, aerospace, building construction, military, packaging, pharmaceutical, medical devices, and other industries. More fascinating, their physical, mechanical, thermal, and other properties may be tailored, offering new technological and economic opportunities.

Polymer nanocomposites are typically prepared by intermingling nanometer-size materials with polymers (or monomers) on the nanometer scale in order to create new materials with better properties than conventional polymer composites. Because nanometer size materials have extremely high surface area and interact with polymers on the molecular level, polymer nanocomposites have different chemistry and properties than conventional polymer composites.

Two groups of thermoplastics, that is, less expensive commodity resins and more expensive and higher performance engineering resins, have received the most commercial interest for nanocomposites. Substitution of engineering resin with less expensive commodity resin nanocomposites with equivalent performance yields overall cost savings. Enhancing engineering resin performance by using a nanocomposite for high end and more demanding applications certainly creates value for the industry.

The prior art is generally focused on polymer and clay nanocomposites, which are composed of individual platelet particles derived from intercalated layered silicate materials and one or more polymers. The existing methodology of forming the intercalate is to increase the interlayer spacing between adjacent silicate platelets by adsorption of a silane coupling agent or an onium cation, such as a quaternary ammonium compound. The intercalated Phyllosilicates, such as smectite clays (e.g., sodium montmorillonite and calcium montmorillonite) are typically used for nanocomposites. These organic molecules, typically having a reactive group compatible with the matrix polymer, can be intercalated between silicate layers to substantially increase the interlayer (interlaminar) spacing between the adjacent silicate layers. The exfoliation (i.e. separation of the silicate layers) typically is accomplished mechanically, for example, by high shear mixing. Admixing individual silicate layers with a matrix polymer can be done before, after, or during the polymerization of the polymer. The polymer and exfoliated intercalated layered silicate admixture has improved properties not typically achievable or possessed by a matrix polymer, such as high mechanical strength.

There are several strategies used to prepare polymer/nanometer-size material nanocomposites with well-defined structures. Three processes mainly used are in-situ polymerization, solvent blending technique, and melt processing technique.

In-situ polymerization involves the dispersion of nanometer-size materials directly into a liquid monomer during the polymerization stage. In the case of nanoclay, the polymerization takes place within the intercalated sheets of layered silicate. In-situ polymerization is restricted to polymers whose monomers are compatible with nanometer-size materials and can be polymerized effectively in the presence of nanometer-size materials. In addition, in-situ polymerization is limited to loadings of nanometer-size materials and by reaction mixture viscosity and polymerization kinetics.

Solvent blending technique employs polar solvents such as toluene, chloroform, butanone, cyclohexanone, tetrahydrofuran, and acetonitrile to integrate the polymer and nanofiller molecules. Nanometer-size materials must be properly dispersed in the solution with the dissolved polymer to ensure good interaction on the nanometer scale level, for example, for polymer to intercalate between the clay layers. However, the solvent must be removed by vaporization usually under vacuum to isolate the nanocomposites. The use of solvents and the solvent drying process are very costly and time consuming and present many environmental and safety issues. This approach is not commercially viable because of problems associated with the use of large quantities of solvents.

Melt processing has the greatest potential in industrial applications. This approach is appealing because melt intercalation is rapid and can be readily achieved via melt blending with conventional polymer processing equipment by utilizing its mechanical shear to break apart the agglomerates and/or the intercalated multi-layer stacks. A broad range of polymers and nanometer-size materials at a wider range of loading may be utilized because a larger selection of compatibilizing agents have a distinct interaction with both polymers and nanometer-size materials. Melt processing can be accomplished using conventional plastic processing equipment such as extruders, injection molding machines, and the like.

However, nanometer-size materials have a strong tendency to agglomerate due to their high surface energy and large specific surface area. Therefore, how to thoroughly distribute and disperse these nanoparticles into the polymer matrix remains a big challenge. In addition, compatibility between the nanofillers and the polymer matrix is also critical. Another challenge is how to prevent reaggregation of nanoparticles during the processing stage once they are homogeneously dispersed. For example, a large percentage of maleic anhydride grafted polyolefins is normally used to help exfoliate and disperse nanoclay particles into the polyolefin matrix. However, nanocomposites lose the desired physical properties because nanoclay particles re-aggregate together again during the processing stage.

Poly(vinyl chloride), PVC, is a unique polymer because of its raw materials. It has a composition of 58 percent chlorine and 42 percent hydrocarbon. Unlike most other polymers, which are mainly hydrocarbons, thus, heavily dependent on the limited supplies of gas and oil, PVC depends on the world's supplies of gas and oil to a lesser extent because the supply of chlorine is, by comparison, virtually limitless. As one of the most often used polymers of the world, PVC is versatile in its applications as a thermoplastic and as a thermoplastic elastomer. PVC serves approximately 69 percent of the construction market for plastics including pipe and fittings, siding, window, fencing, and decking, approximately 58 percent of the wire and cable plastics market, and approximately 25 percent of the coating market, and approximately 2 percent of the packaging market. It is the dominant material in certain segments of the custom molding (thin wall) market.

Although PVC is one of the world's most largely used polymers, it has received little attention in the field of nanocomposite research and development. There has been very limited research work on PVC nanocomposite. Most research work on PVC nanocomposite has focused on flexible PVC applications. Very little research work has been directed toward rigid PVC applications. Several different methods are used for PVC nanocomposites, that is, in-situ polymerization, melt processing, and solvent blending. Some researchers report that in-situ polymerization results in a more homogenous dispersion than melt blending of PVC/organoclay nanocomposites, which have larger organoclay agglomerates.

For PVC/organoclay nanocomposites, montmorillonite (MMT), kaolinite, and other clays are typically used for some potential applications. MMT consists of silicate layers of approximately 200 nm long and 1 nm thick with its interlayer spacing of approximately 1 nm. Its silicate layers can be expanded and even delaminated by proper organic treatments. These nanometer scale silicate layers can be dispersed in the PVC matrix by melt processing or forms the reinforcement phase on a molecular level by in-situ polymerization. However, it is found that quaternary alkylammonium salts between the interlayers of organic treated montmorillonite (MMT) initiates the PVC degradation and then speeds up degradation process by further catalyzation. Plasticizer, such as dioctylphthalate (DOP), may be used as a co-intercalating agent for organic treated MMT and PVC, which serves a barrier between organic treated MMT and PVC to avoid the direct contact of organic treated MMT with PVC. In this way, the degradation of PVC is prevented or at least minimized. However, the mechanical properties of PVC/MMT nanocomposites may not be enhanced significantly because the MMT only acts as a plasticizer carrier.

U.S. Pat. No. 6,271,297 describes a problem of PVC degradation. The exfoliated PVC/clay nanocomposites are prepared with or without epoxy, which has a solubility parameter identical to PVC. Because epoxy and PVC are completely miscible and have the same affinity for the clay, they disperse the clay layers together. In the absence of epoxy, PVC quickly turns purple then black, which is a visible sign of the PVC degradation when the clay is added and exfoliation begins. With the presence of the epoxy, thermal degradation is not observed because the clay surface and the exchange cation are coated with the epoxy and direct contact with the PVC is avoided.

W. Xu, M. Ge, and W. P. Pan (Journal of Thermal Analysis and Calorimetry, Vol. 78, 2004) investigated the effect of organic treated MMT content on the glass transition temperature and mechanical properties of PVC/MMT nanocomposites utilizing melt blending technique. They found that PVC chains had intercalated into gallery of organic treated MMT to form exfoliated PVC/MMT nanocomposites. Their results showed that PVC/MMT nanocomposites had lower glass transition temperatures than neat PVC because of decreases in the interaction forces between PVC chains due to the MMT plates acting as a plasticizer. The tensile strength, notched Izod impact strength, and notched Charpy impact strength of PVC/MMT nanocomposites decreased with the increase of the glass transition temperature for PVC/MMT nanocomposite in a linear fashion.

H. Haiyan, et al (Polymer International 53:225-231, 2004) researched PVC/organoclay nanocomposites by in-situ polymerization and melt blending as well as the effect of ammonium cations on the nanostructures of the nanocomposites. They concluded that in-situ polymerization generated a better dispersion of the organoclay with the type of organoclay having little effect on the morphologies of the PVC/organoclay nanocomposites. This is because monomer intercalation is kinetically much easier than polymer chain intercalation. Before polymerization, vinyl chloride monomer (VCM) penetrates into the silicate layers of the clays. The polymerization of VCM inside the silicate layers expands or even exfoliates the silicate layers, resulting in the organoclays homogenously dispersed in the PVC matrix. They also discovered that the melt blending produced a less homogenous dispersion with the presence of much larger organoclay agglomerates than in-situ polymerization. Although the very large PVC chains have difficulty entering into the galleries of organoclays, they do diffuse into the silicate layers once sufficient chain mobility is achieved. The interactions between PVC chains and the organic chains in the galleries and silicate layers play an important role in dispersion. Without such interactions, the intercalated structure is unstable. Other factors affecting intercalation are the surface polarity difference between PVC and organoclay and the chain length and structure of surfactant cation. When the surfactant cation has the proper hydrophobicity and compatibility with PVC and a relatively weak interaction with the silicate layers, the silicate layers can be dispersed in the PVC matrix to form a partially exfoliated PVC/organoclay nanocomposite.

D. C. McConnell, et al (Conference Proceeding of Nanocomposites 2005, Aug. 22-24, 2005, San Francisco, Calif.) studied PVC/ethylene-vinyl acetate-carbon monoxide terpolymer (EVA-CO)/synthetic fluorohectorite clay nanocomposite for medical device applications by melt blending. Their results showed the PVC/EVA-CO nanocomposite consisted of a mixture of intercalated and partially exfoliated clay structures. Mechanical properties of the PVC/EVA-CO nanocomposites were not significantly improved, but the Young's modulus and elongation at break were remarkably better than those of the neat PVC/EVA-CO blend. The barrier properties were considerably better than those of the neat PVC/EVA-CO blend. The nanocomposites also displayed a higher glass transition temperature and the similar melt viscosity as compared to the neat PVC/EVA-CO blend. They reported that the carbonyl group in the EVA-CO terpolymer enhances compatibility with the fluorohectorite clay and make it possible to form flexible blend with PVC due to the interaction of the carbonyl group with the α-hydrogen of PVC. Because EVA-CO has relatively lower melting temperature and much lower viscosity than PVC, it melts faster than PVC and forms a barrier between the PVC and the clay surface to minimize contact between the PVC and the quaternary alkylammonium on the clay surface, thus preventing degradation of the PVC. At the same time, EVA-CO is also an effective intercalating agent for the organic treated clay. The higher viscosity of PVC at the downstream of the extruder also imparts greater stress to promote the EVA-CO penetration into the clay interlayer galleries. Although EVA-CO, an expensive additive, prevents PVC degradation caused by the quaternary alkylammonium in the flexible PVC nanocomposite application, it has to be used at a very large quantity by tumble mixing in a 60:40 PVC:EVA-CO ratio with nanoclays. Its melt compounding process is complicated due to the requirements of stave feeding the remaining 20% of PVC at downstream approximately ¼ of the full screw length. These disadvantages make this approach not commercially viable. In case of rigid PVC applications, although EVA-CO, such as [DUPONT ELVALOY™], can be used as an impact modifier, it is much more expensive than conventional impact modifiers such as acrylics and chlorinated polyethylene and may not be powder-blendable in the high intensity mixer typically used in the PVC dry blending operation.

J. L. Capitaneo, et al (Applied Mineralogy, Pecchio et al. (eds.) 2004 ICAM-BR, Sao Paulo, ISBN 85-98656-01-1) studied PVC/kaolinite nanocomposites. Kaolinite, a clay mineral with the chemical composition Al₂Si₂O₅(OH)₄, is a layered silicate mineral with one tetrahedral sheet linked through oxygen atoms to one octahedral sheet of alumina octahedral. First, they used dimethyl sulfoxide (DMSO) as an intercalating agent to increase the interlayer spacing within the kaolinite. Then, they melt blended treated kaolinite with PVC. Intercalation of PVC with treated kaolinite took place by gradually displacing the DMSO molecules on the kaolinite. They concluded that PVC/Kaolinite nanocomposite had higher glass transition temperature and better thermal stability than the bulk PVC. This method requires extremely long reaction time (5 days) of PVC with DMSO modified kaolinite and long drying time (3 days). In addition, as a strong solvent, DMSO is displaced by PVC as PVC intercalation slowly proceeds and must be separated and recycled.

D. Wu, et al (Journal of Applied Polymer Science, Vol. 92, 2714-2723, 2004) conducted research on nanocomposites of PVC and nanometric calcium carbonate particles via melt blending, with chlorinated polyethylene (CPE) as an interfacial modifier. The powder mixtures were mixed in a high-speed mixer followed by melt blending on a laboratory two-roll mill. They observed a moderate toughening effect for PVC/nano-CaCO₃ binary nanocomposite. The tensile strength of PVC/nano-CaCO₃ at 5 percent loading level of nano-CaCO₃ was slightly higher than that of pure PVC. Further increasing the nano-CaCO₃ loading level decreased the tensile strength in almost a linear fashion. The elongation at break and Young's modulus increased with increasing the nano-CaCO₃ loading level. They found that most nano-CaCO₃ was dispersed as primary particles with some agglomerates still present with or without the presence of CPE. More agglomerates were found at the higher nano-CaCO₃ loading level. It was difficult to disperse nano-CaCO₃ particles homogeneously in the PVC matrix because of its strong tendency to agglomerate. By incorporating CPE into the nanocomposites, the tensile strength of PVC/CPE/nano-CaCO₃ nanocomposites decreased with increasing nano-CaCO₃ loading level, while Young's modulus and elongation at break increased with increasing nono-CaCO₃ loading level. The notched Izod impact strength of PVC/CPE/nano-CaCO₃ nanocomposites was significantly improved due to a synergetic effect of CPE and nano-CaCO₃. However, all work was done on a laboratory two-roll mill at specific conditions. These results may not be duplicated on other commercial scale processing equipment such as an extruder and injection molding machine. In addition, this method requires a complicated process not feasible for industrial application, that is, to prepare CPE/nano-CaCO₃ master batches first by melt blending in a two-roll mill at 130° C. for 10 minutes, and then melt blend PVC with CPE/nano-CaCO₃ master batches via a laboratory two-roll mill at 50 rpm and 175° C. for 10 minutes.

C. Xiong, et al (Nanotechnology, 16, 1787-1792, 2005) prepared PVC/CaCO₃ nanocomposites by a different approach. They first produced microporous PVC with a pore size of 0.2-2 μm through foaming of PVC solution in butanone and cyclohexanone using 2,2′-azo-bis-iso-butyronitrile. The CaCO₃ nanoparticles were made inside the pore of microporous PVC through the reaction of Ca(OH)₂ with CO₂ and then deposited inside the pore of PVC. The PVC/CaCO₃ hybrid powders were then processed into PVC/CaCO₃ nanocomposites by melt blending. Results from SEM and TEM showed that the CaCO₃ nanoparticles with sizes less than 50 nm were uniformly dispersed in the PVC matrix. The resultant PVC/CaCO₃ nanocomposites exhibited much higher strength, modulus, toughness, and glass transition temperature than the nanocomposites prepared by direct dry blending. However, the use of a large amount of solvents make this method undesirable.

Typically melt shear mixing is capable of dispersing minerals in a polymer melt down to the micron scale as is described in U.S. Pat. Nos. 4,618,528 and 4,528,235. However, simply increasing mechanical shear forces in the melt mixing process is not able to fully break down agglomerates and then disperse homogeneously the nanoparticles into the polymer matrix without degrading the polymer matrix, especially heat and shear sensitive polymer such as PVC.

In summary, conventional processes used to produce polymer composites for decades is no longer effective to produce polymer nanocomposites with nanofillers. This is because nanometer-size grains, fibers, and platelets possess dramatically higher surface area than their conventional-size materials, thus they are extremely difficult to disperse into the polymer matrix due to strong van der waals forces. Poor dispersion of nanometer size materials into the matrix leads to reduction of strength and modulus because nanometer size materials tend to bond strongly together. Conventional processing technology does not have enough power to break down these particle-to-particle attraction forces to disperse nanometer-size materials homogeneously in the matrix.

The prior art of synthesizing nanocomposites focuses on increasing the interlayer (interlaminar) spacing between adjacent layers of nanometer-size materials. These techniques involve multiple complicated, lengthy, and difficult steps. All these steps add expensive cost to nanocomposites. In the contrary, coating PVC primary particle with nanometer-size materials is relatively simple. The present invention applies rheological principles to successfully resolve the dispersion issue of nanometer-size materials in the polymer matrix.

In most cases the performance advantages that nanocomposites offer normally far outweigh the costs and other concerns. However, many PVC markets are price-sensitive. The nanotechnology growth in many PVC markets, especially in rigid PVC applications such as pipe and fitting, siding, window, door, fencing, decking, and the like, is impeded by cost considerations. The ability for PVC nanocomposites to add value and performance is presently inhibited by the high processing costs of PVC nanocomposites, nanofillers, and other nano-additives. The existing nanotechnology reported in the literature fails to meet the stringent cost requirements of the PVC markets. Besides, it is a big challenge to utilize high shear mechanical forces to thoroughly disperse the nanoparticles into the heat and shear sensitive PVC matrix without deteriorating the PVC matrix. Therefore, developing a viable and cost-effective PVC nanotechnology that allows PVC processors to lower their costs and at the same time produce a product with better processing performance and enhanced material performance is desirable.

### SUMMARY OF THE INVENTION

The present invention provides a process and a product of forming polymer (especially PVC) nanocomposites with a variety of nanofillers. The present invention also provides a method encompassing both formulating and processing methods for forming a polymer nanocomposite with a homogeneous dispersion of nanofillers in the polymer matrix. The present invention provides a method for forming a polymer nanocomposite, comprising powder mixing a composition comprising polymer resin, a nanofiller, and a coupling agent for a residence time of about 4 to about 8 minutes to form a dry blend and extruding the dry blend in an extrusion process. Additionally, the present invention provides a polymer nanocomposite formed by a process, comprising powder mixing a polymer resin, a nanofiller, and a coupling agent for a residence time of about 4 to about 8 minutes to form a dry blend and extruding the dry blend in an extrusion process to achieve homogeneous dispersion of nanofillers in the polymer matrix.

### DETAILED DESCRIPTION

In general, the present invention relates to a new polymer (particularly PVC) nanocomposite and a manufacturing method thereof. The polymer nanocomposite has nanometer-size materials dispersed individually in the polymer matrix. The present invention uses rheological techniques to form a polymer nanocomposite with a variety of improved properties. In particular, the invention relates more to utilizing polyvinyl chloride (PVC) and nanofillers, including but not limited to, exfoliate layered silicates, silica, calcium carbonate, titanium dioxide, zeolite, hydrotalcite, mica, talc, silver, carbon black, graphite, and other nanometer size materials to produce PVC nanocomposite materials via powder mixing and melt processing.

Polymer resins suitable for use in the present invention include, but are not limited to, polyvinyl chloride (PVC), chlorinated polyvinyl chloride (CPVC), and other potential polymers described below. The preferred resin for the present invention is polyvinyl chloride (PVC). The present invention may be applied to both rigid and flexible PVC formulations. As used herein, the definition of a “rigid” formulation is a formulation having a plasticizer in a concentration of zero to less than about 5 parts per hundred of resin (phr). A “flexible” formulation typically has a plasticizer in a concentration from greater than about 5 to as much as about 150 parts per hundred of resin (phr).

Several types of commercial PVC maybe used. Depending on the intended applications, commercial polymerizations of PVC are carried out within the range of about 45° C. to about 70° C. A lower polymerization temperature is generally used to produce a higher molecular-weight resin. The properties of PVC resin can vary depending on the polymerization method and polymerization temperature. PVC reins typically have a weight average molecular weight in the range of about 39,000 (inherent viscosity=0.51, K value=49, weight average degree of polymerization=625) used for injection molding of thin-walled parts to about 168,000 (inherent viscosity=1.60, K value=91, weight average degree of polymerization=2700) used for plasticized PVC having outstanding compression set. For particular applications, certain molecular weight PVC resins may be selected for optimum physical properties and process performance. Generally, suspension PVC resins have better thermal stability than PVC resins produced by mass or emulsion polymerization. Other properties such as average particle size, particle size distribution, porosity, and the like may greatly affect the performance of PVC resin in the same formulation.

Because the chlorine presented in the PVC molecular structure is more electronegative than carbon or hydrogen, PVC is a somewhat polar polymer. The strength of PVC comes from electrostatic forces between different molecules resulting from the presence of this molecularly bound chlorine, hydrogen bonding, chain entanglements, and crystallinity. Although PVC is a typical amorphous polymer, commercial PVC normally has a small amount of crystallinity in the range of 5 to 10 percent, which has a profound effect on some physical properties of PVC. The particular polarity of PVC renders an ability to form compatible compositions with many other polymers, plasticizers, and other formulating ingredients. Other polymers with more or less polarity do not have this wide range of formulating flexibility.

The morphology of PVC resin powders depends on how the resin is manufactured. The particle structure, such as average particle size, particle size distribution, particle shape, porosity, internal structure, pericellular membrane, and the like, has a great impact on processability of PVC. During polymerization, the precipitated polymer chains clump together to form domains (˜0.1 micron meter in size). The further agglomeration and growth of these domains form primary particles (˜1 micron meter in diameter). A group of primary particles generally encased in a skin membrane form irregularly shaped grains (˜100 micron meter in size).

Unlike most thermoplastics, PVC is a shear-sensitive, heat-sensitive, and ultraviolet light sensitive polymer. PVC resins are stabilized and mixed with other formulating ingredients, including, but not limited to, thermal stabilizers, plasticizers, lubricants, processing aids, impact modifiers, antioxidants, ultraviolet light stabilizers, hindered amine light stabilizers, fillers, pigments, and combinations thereof, then processed into useful articles. Most applications for PVC require a well-balanced formulation with all ingredients carefully selected. In addition, rigid PVC is processed into economical structural articles. Therefore, it must be formulated at minimum expense to its structural properties, such as heat distortion temperature, modulus, resistance to abrasion, and the like.

The nanometer-size materials used in the present invention are nanofillers. Nanofillers are commonly defined as nanometer-size additives in particulate form, which generally comprise inorganic materials, more rarely organic materials. They differ from the polymer matrix in terms of their composition and structure. Nanofillers are intended to improve certain mechanical or physical properties by the formation of a chemical bond (such as cross linking by carbon black in elastomers), filling of a certain volume and disruption of the conformational position of a polymer matrix, and also the immobilization of adjacent molecule groups and possible orientation of the polymer material. A dry blend of polymer nanocomposite may contain nanofiller ranging from 0.1 to 20 weight percentage of the dry blend.

There are a variety of nanofillers commercially available, including but not limited to boehmite alumina (synthetic) nanofillers, aluminorganic nanofillers, calcium carbonate nanofillers, ceramic nanofillers, carbon black nanofillers, carbon nanotube nanofillers, cellulose nanofillers, activated clay nanofillers, natural clay nanofillers (mined, refined, and treated), clay (synthetic) nanofillers, organo clay nanofillers, natural fiber nanofillers, gold nanofillers, graphite nanofillers, hydrotalcite nanofillers, kaolin nanofillers, magnesium hydroxide nanofillers, mica nanofillers, mineral nanofillers, montmorillonite clay nanofillers, phosphate nanofillers, poly oligomeric silsesquioxane (POSS) nanofillers, silica nanofillers, silver nanofillers, talc nanofillers, antimony pentoxide nanofillers, organo-titanate nanofillers, titanium white nanofillers, Wollastonite nanofillers, zeolite nanofillers, zinc oxide nanofillers, organo-zirconate nanofillers, zirconia nanofillers, alumina trihydrate (ATH), and similar nanofillers. The mean particle sizes of these nanofillers suitable for the present invention may be in the range of 1 nm to 1000 nm, preferably 5 nm to 500 nm, and more preferably 20 nm to 300 nm, depending on the applications. Nanofillers of varying shapes may be used for PVC nanocomposites including irregularly shaped materials, spherical materials, and high aspect ratio materials with aspect ratios as high as 500:1.

Because of their large surface areas, nanofillers are typically used as reinforcing fillers to enhance toughness, flame retardancy, rheological properties, and the like if they are finely dispersed in the polymer matrix. Better dispersion can be achieved by reducing the high surface energy of these nanoparticles to improve the compatibility and interaction with the polymer matrix, such as with a suitable organic surface treatment, using coupling agents, and the like. One example is the modification of the inorganic surface of layered silicates with an organophillic reagent such as an alkylammonium, or a chelating agent, to render them compatible with a variety of polymers.

In the present invention, nanofillers may suitably be formulated with PVC, coupling agents and/or compatiblizers, and a variety of property-modifying additives conventionally employed for PVC resins to the extent that the presence of any such property-modifying additives does not interfere with the performance of the composition of the invention. These property-modifying additives include, but are not limited to, thermal stabilizers, plasticizers, lubricants, processing aids, impact modifiers, antioxidants, ultraviolet light stabilizers, hindered amine light stabilizers, and the like, or combination thereof, to vary the resultant properties.

Other property-modifying ingredients employed for PVC resins are fillers and pigments, including one or more treated or untreated inorganic materials, such as talc, calcium carbonate, alumina trihydrate, barium sulfate, calcium sulfate, carbon black, mica, titanium dioxide, or combinations thereof. These fillers can be included in the PVC nanocomposite blends for various applications. The amount of these fillers and other additives present in the PVC nanocomposite varies depending on the applications.

The surface treatment for nanofillers, compatibilizer, and/or coupling agents contemplated for use in the practice of the present invention includes fatty acids, fatty acid derivatives, silanes, titanates, zirconates, aluminates, surfactants, plasticizers, resins with a melting point lower than PVC, and other ingredients, for example, stearic acid, hydrogenerated fatty acid, ester of fatty acids and fatty alcohols, partial fatty acid ester of glycerine, metal carboxylate, 3-aminopropyl trimethoxy silane, titanium IV 2,2(bis 2-propenolatomrthyl)butanolato, tris(dioctyl)pyrophosphato-O, zirconium IV 2-ethyl, 2-propenolatomethyl 1,3-propanediolato, cyclo di 2,2-(bis 2-propenolatomethyl)butanolato pyprophosphato-O,O, epoxidized soybean oil, diisodecyl phthalate, oxidized polyethylene, chlorinated polyethylene, or combinations thereof. These additives improve compatibility and/or bonding properties of nanoparticles in the discrete phase with the PVC continuous melt phase through the reduction of interfacial tension. Thus the resulting good adhesion of nanoparticles to the PVC not only facilitate effective stress/strain transfer to agglomerates of nanoparticles to break them up and disperse them, but also is critical to maintain the state of dispersion.

Depending on the application, nanocomposites in accord with the present invention will have from 30 to 98 weight percent polymer resin and 0.1 to 20 weight percent nanofiller. For rigid PVC applications, the nanocomposite will commonly have from 70 to 98 weight percent PVC and 0.1 to 20 weight percent nanofiller. For flexible PVC applications, the nanocomposite will commonly have from 30 to 90 weight percent PVC and 0.1 to 18 weight percent nanofiller.

Typical powders made of nanofillers have a tendency to agglomerate, are extremely difficult to disperse satisfactorily, and do not normally disperse to the ultimate particle size of the powder. This in turn results in poor mechanical and physical properties. In order to create PVC nanocomposites with enhanced properties, it is necessary to break these agglomerates into the primary nanoparticles and homogeneously disperse these primary nanoparticles into the PVC matrix.

The present invention employs a two-step process to produce PVC nanocomposite, involving powder mixing followed by melt processing (or melt compounding or melt blending or melt mixing). Powder mixing is typically fulfilled using a high-speed (high-intensity) mixer, for example, Henschel and Littleford Mixer for distributive mixing, which does not involve size reduction but only increases the interfacial area between the polymer matrix and nanofillers. Distribution may take place without causing dispersion. Melt processing normally uses conventional processing equipment such as an extruder to achieve dispersive mixing, which reduces the size of agglomerates of nanoparticles. Dispersion typically results in distribution as well.

High-speed mixers are typically vertical, cylindrical drums that have a single, bottom-entering vertical drive shaft. The mixing blades are mounted on the shaft in a cross pattern and can sweep the entire diameter of the mixing drum. The mixing blades, typically having high tip speeds of 5,000 to 8,000 feet per minute, create the intense vortex mix action of materials in a rotating horizontal movement coupling with a cascading vertical movement. These concurrent actions and the intense swirling vortex lift materials up along the periphery of the drum, and then deflect materials down through the vortex and into the mixing system again. Various particles of PVC, nanofillers, and other additives impact each other at the interface of upward and downward flow stream, the mixer wall, and the blades, thus generating the heat required for deagglomeration, distribution, impingement of powder additives or absorption of liquid additives into the PVC resin, and maximizing product density. The high-shear forces of the high-speed mixer effectively disaggregate clusters of particles, especially nanoparticles and distribute them uniformly in the mixture. The attrition of large agglomerates of nanoparticles plays an important role in the final uniformity of the blend. However, powder mixing only involves the addition and distribution of relatively small amount of nanofillers and other additives in PVC powder without melting the PVC. The resulting powder mixture continues to flow as a powder. Both PVC grains and nanofillers are not reduced in size or dispersed. Rather, PVC, nanofillers, and other additives remain as agglomerates without being fully broken down to their respective primary particles. Powder mixing is generally not dispersive and is used only as the first step to achieve a uniform mixture. Uniform mixture means the mixture has an equivalent composition at any part so that no segregation occurs later.

The powder mixing process may be accomplished by a conventional high intensity mixer such as Henschel and Littleford mixers. The mixing procedure is comparable to PVC mixing when no nanofiller is added to the blend and the overall cycle time is also within the range of conventional PVC dry blending. In order to break up the large cluster of nanofillers into finest possible agglomerates, sufficient mixing time is important to achieve the uniform mixture. To obtain a uniform mixture, nanofillers are added with PVC at the very beginning of the cycle. The residence time of nanofillers in the high intensity mixer is typically 4 to 8 minutes to ensure the best distribution of nanofillers in the dry blend. As a comparison, the traditional fillers in the conventional PVC dry blending process are normally added at the very end of the mixing cycle and thus experience a residence time of only about 1 minute. To achieve the maximum distribution of nanofillers and, at the same time, avoid PVC degradation, the discharge temperature of the dry blend in the high intensity mixer is typically in the range of 100° C. to 115° C. depending on the applications.

Because the subsequent melt processing equipment such as a twin-screw extruder has virtually no back mixing, the uniform mixture ensures production of a nanocomposite with a constant composition at a constant rate. Because the powder mixtures inside the high intensity mixer are rapidly heated up by frictional heat, they are normally discharged into a mixer cooler (or cooling mixer) integrated with the high intensity mixer when the temperature increases to 100° C. to 115° C. Rapid cooling is important for quick removal of excessive heat from heat-sensitive PVC prior to storage. Because PVC has poor thermal conductivity, materials in the interior of the bulk storage container may degrade over a period of a few days and have a tendency to cake inside the container. There are basically two types of mixer coolers: ribbon blenders and tank mixers, both consisting of a large diameter and low height jacketed bowl equipped with a series of rotors that operate at low speeds. The rotors move the powder mixture to provide maximum surface contact with blades and jacket that the coolant circulates through. In some cases the mixer cooler is oversized so that it can hold 3 to 4 batches of the powder mixtures from the high intensity mixer to improve production efficiency and the product quality consistency.

Melt processing of the powder mixture used in the present invention employs a direct powder to finish product approach. A conventional twin-screw extrusion is desirably used. Conical twin-screw extruder and cylindrical twin-screw extruder, both fully intermeshing and counter-rotating, may be used to extrude PVC nanocomposites. PVC nanocomposites may also be processed into compounded pellets with an internal batch mixer (Banbury) and mill, an internal continuous mixer (Farrel Continuous Mixer) and mill, reciprocating single screw compounder (Buss Kneader), co-rotating twin-screw extruder, and the like.

Twin-screw extrusion is a fabricating process by which PVC compounds are converted continuously to a flowable melt by heat and shear, forced under pressure down the barrel through an adapter and then a shaping die, and entered into a downstream calibrating equipment to produce sheet or profile structures such as pipe, siding, window profiles, and a multitude of custom shapes. It has the ability to process PVC compounds at low speed (rotation per minute or rpm) and relatively low temperatures to avoid problems of degradation. The twin-screw extruder has functions of producing the proper feed, compression, plastification, degassing, mixing, metering, and pumping. The counter-rotating fully intermeshing twin-screw extruder has a screw design that traps material in “C” shaped compartment within the channel of each screw, keeps material from moving from one screw to the other, and forces material to advance much like a stationary nut on a rotating screw. Although there are restrictions to lower screw speed due to a large separating force between the screws, good dispersion is provided by calendering or milling the material between screws and the drag action between the flanks of the screw flights and the screw tips and the barrel wall. It also has an advantage of self-cleaning with a thermally sensitive polymer like PVC. The counter-rotating fully intermeshing twin-screw extruder is normally fitted with an independent metering feeder to use feed rate to control the amount of mechanical work put into the extrudate. Typically it runs only partially full at most screw flights and full only in the last few screw flights due to the back pressure buildup of a die.

When the uniform powder mixtures of PVC, nanofillers, and other additives feed into the extruder or other melt processing devices, PVC grains (˜100 micron meter) and nanoparticle agglomerates start to break up when subject to high heat and shear. As the mass temperature increases and more mechanical shear energy is transferred, PVC primary particles start to melt gradually to form bigger agglomerates with a significant increase of viscosity. Further increase of mass temperature and shear results in melting most PVC primary particles, thus forming a continuous melt phase with discrete nanoparticle agglomerates imbedded in the matrix.

In order to achieve the optimum performance advantages nanofillers can provide, nanoparticle agglomerates must be broken down to their primary particles and then fully dispersed into the PVC matrix. Exposure of large surface area of nanofillers allows interaction of nanofillers with PVC domains on a molecular level. When the product cools down, the primary nanoparticles are trapped within the entangled PVC chains thus resulting in improved mechanical and physical properties. Dispersion is a critical step for the success of PVC nanocomposites.

As previously indicated, the present invention employs conventional melt processing devices such as twin-screw extruder to do the dispersion work. For example, conical fully intermeshing counter-rotating twin-screw extruder applies mechanical energy, both shear and elongational work, to disperse the nanoparticles into the PVC matrix. The elongational work is normally only achieved at the bottom of the barrel where the screw flights meet to intermesh.

There are typically two types of polymer flow: shear flow, which occurs due to a pressure drop through a flow path, and elongational (or stretching or extensional) flow, which occurs due to a tensile (or compressive) stress associated with stretching (or compression). Since the shear flow and elongational flow are both laminar for highly viscous polymer melt, they are ineffective for distribution. However, orientation of the flow stream in the shear flow facilitates effective distribution especially at low stress level. Dispersion takes place only if the stress is sufficiently high to break up the dispersed phase, such as the domain of the additional component or agglomerates of nanoparticles.

In case the dispersed phase is a liquid, the effectiveness of domain breakup depends on the viscosity ratio of droplet viscosity to continuous phase viscosity. The optimized viscosity ratio for dispersion is in the range of 0.1 to 1 for both shear and elongational work. In the shear flow, the droplet does not break up but rather extend to a thinner thread at very low droplet viscosity. When the viscosity ratio is greater than 3.5, domain breakup is impossible in the shear flow even at the highest stress available because the droplet rotates and remains spherical in the shear field. In contrast, domain breakup occurs in the two-dimensional elongational flow from extremely low viscosity ratio to high viscosity ratio as over 800. Overall, elongational work provides much more efficient dispersion than shear work.

In case the dispersed phase is a solid such as agglomerates of nanoparticles, shear work rotates agglomerates but is unable to break them up. Increasing mechanical shear, for example, increasing screw speed, makes dispersion less likely. This is because higher hydrostatic pressure is also developed to further compress the agglomerates, increasing their cohesive strength. Therefore, breakup of the agglomerates becomes even harder at higher mechanical shear. In addition to that, higher mechanical shear has the potential problem of degrading the PVC matrix. It seems that elongational work is the only means for effective breakup of agglomerates. Since the agglomerates of nanoparticles are very cohesive, the elongational stress must be higher than the cohesive strength of the agglomerates to break them up and disperse them into the PVC matrix.

To achieve better dispersion, it is desirable to minimize shear work and maximize elongational work. There are two attributes of the present invention that contribute to maximizing elongational work: processing conditions used and the materials employed. First, from the standpoint of processing conditions, there is an operating strategy such as slightly cooling the barrel and screw to reduce shear but increase elongational work for dispersion because cooling allows slightly more slip. The barrel and screw temperature may be selected to be about 0° C. to about 20° C. cooler than an extrusion process with no nanofiller present, about 180° C. to about 195° C. However, too much cooling results in swirls in the melt, thus finish products with poor properties. The other operating strategy is to increase total mechanical work by keeping a fuller main screw. This also boosts elongational work for dispersion. However, shear work also increases, resulting in higher melt temperature. Since PVC is quite shear-sensitive, too much shear heating must be avoided before degradation occurs. Therefore, manipulating processing conditions of conventional melt processing equipment alone may not be able to thoroughly disperse the primary nanoparticles into the PVC matrix. Second, from the standpoint of the nanocomposite material itself, how to select proper additives and how to formulate a combination of these additives with PVC and nanofillers play a critical role in the success of PVC nanocomposites. A formulating methodology practiced in this invention enables PVC nanocomposite formulations to maximize elongational work and at the same time to minimize shear work to their melts during extrusion process, thus resulting in homogeneous dispersion of the primary nanoparticles into the PVC matrix.

Among the published art, there are no disclosures on the use of rheological technology empowering PVC nanocomposite formulations to minimize shear work and maximize elongational work or to effectively convert shear work to elongational work at a given total mechanical energy during extrusion process to promote homogeneous dispersion of nanoparticles in the polymer matrix. Although the present invention relates more specifically to PVC, the methodology and technology of this invention may be applied to all polymers that are suitable for nanocomposites. Polymers that can benefit from the present invention include, but not limited to, polyvinyl chloride (PVC), chlorinated polyvinyl chloride (CPVC), acrylics, acrylonitrile-butadiene-styrene copolymer (ABS), acrylonitrile-styrene-acrylate (ASA), aliphatic polyketone, alkyd resins, elastomers, thermoplastic olefinic elastomer (TPO), epoxy resins, ethylene vinyl acetate copolymer (EVA), ethylene-ethyl acetate copolymer (EEA), ethylene-propylene copolymers (EPR & EPDM), ionomers, liquid crystalline polymers (LCP), perfluoroalkoxy resin (PFA), phenolic resins, poly(acrylic acid) (PAA), polyamides (PA), polyamideimide (PAI), polyamines, polyaniline (PANI), polyaryletherketone (PAEK), poly(butylenes terephthalate) (PBT), polycarbonate (PC), polyetheretherketone (PEEK), polyetherimide (PEI), polyether sulfone (PES), polyethylene (PE), chlorinated polyethylene (CPE), chlorosulfonated polyethylene (CSM), poly(ethylene oxide) (PEO & PEG), poly(ethylene terephthalate) (PET), polyimide (PI), polymethylmethacrylate (PMMA), polyoxymethylene (POM), poly(phenylene ether) (PPO), poly(phenylene sulfide) (PPS), polypropylene (PP), polypyrrole, polystyrene & high impact (PS & HIPS), polysulfides, polysulfone (PSO), polytetrafluoroethylene (PTFE), polyurethanes (PU & TPU), poly(vinyl acetate) (PVAc), poly(vinyl alcohol) (PVAl), poly(vinyl butyral) (PVB), rubbers such as natural rubber (NR), nitrile rubber (NBR), polybutadiene rubber (BR), polybutyl rubber (HR), polychloroprene (CR), polyisobutylene (PIB), polyisoprene (IR), and styrene-butadiene rubber (SBR), silicones (SI), styrene-acrylonitrile copolymer (SAN), tetrafluoroethylene-perfluoropropylene (FEP), unsaturated polyesters, vinylidene-fluoride terpolymers (PVDF), and the like, as well as derivatives thereof, and combinations thereof.

The present invention relates to a technology that manipulates shear work and elongational work to form homogeneous PVC nanocomposites. Shear work generated by the extruder at an initial melting and mixing section of the extruder at the beginning of the process heats up the powder mixture by friction and viscous flow and raises melt temperature to a desired point where there is a need to switch to elongational work for dispersion. At a desired point, shear work is converted to elongational work, thus significantly increasing elongational work for thorough dispersion at the given total mechanical energy. A formulating methodology in this invention uses the right combination of ingredients at the right level to achieve the right dispersion of nanoparticles into the polymer matrix by conventional processing equipment without any modifications of equipment and processing conditions. In one aspect, this technology effectively converts shear work of conventional processing equipments into elongational work by mastering nanocomposite compositions and/or processing conditions. The advantage is that elongational work is maximized while shear work is minimized at the given total mechanical energy applied to the melt mixture. The total mechanical energy is generated by conventional processing equipments and defined as the sum of shear work and elongational work. In other aspect, this technology reduces shear work to the PVC matrix, thus avoiding property deteriorations because of PVC degradation due to excessive shear heating. In another aspect, this technology increases elongational work to the interface between agglomerates of nanoparticles and the polymer melt phase by controlling the viscosity and the melt temperature of the continuous polymer phase to achieve effective dispersion of nanoparticles. In another aspect, this technology enables transfer of mechanical energy, through coupling agents and/or compatibilizers, from the continuous polymer phase to the discrete phase, that is, agglomerate of nanoparticles, to break them up and disperse them.

Nanofillers have high cohesive strength because of their large specific surface areas and high surface energy. They are typically not compatible with the polymer matrix. The agglomerates of nanoparticles in a highly incompatible polymer matrix with a high interfacial energy may coalesce after being dispersed, forming agglomerates again to reduce the interfacial areas. Maintaining the state of dispersion is as critical as dispersion itself. Two techniques to obtain and maintain the nano-scale dispersion are selecting proper surface treated nanofillers and utilizing compatibilizers and/or coupling agents to improve the compatibility between nanofillers and the PVC matrix. The dispersed primary nanoparticles are adhered to PVC and interact with PVC at a molecular level.

### EXAMPLES

A few specific examples are presented as follows to more specifically illustrate the present invention. However, the technology of the present invention is not limited to the following examples and may be applied to other polymer nanocomposites.

### Example 1

### Dry Blending Procedures

The basic dry blending procedures described in this Example were, unless indicated to the contrary, utilized for all subsequent examples. PVC and nanofiller are dry blended in a high intensity mixer to produce a uniform powder mixture. In the typical blending procedure, PVC and nanofiller are dry blended along with other components, notably coupling agents and property modifying additives, including thermal stabilizers, lubricants, processing aids, impact modifiers, ultraviolet light stabilizers, fillers, and/or pigments. The PVC, nanofiller, coupling agent, and thermal stabilizer are added at the very beginning of the mixing cycle, followed by adding lubricants when the temperature reaches 60° C., adding impact modifiers and processing aids when the temperature reaches 71° C., adding ultraviolet light stabilizers, fillers, and/or pigments when the temperature reaches 82° C., and discharging the powder mixture into a cooler when its temperature reaches 105° C.

PVC (Formolon H622, a commercial grade PVC available from Formosa Plastics Corporation of Point Comfort, Tex.) was used at approximately 80 weight percent and a nanofiller was used at approximately 4.4 weight percent in the powder mixture. The specific nanofiller used is described for the subsequent Examples. A composition comprising esters of fatty acids and fatty alcohols was used as the coupling agent at 0.1 to 1.0 weight percent in the powder mixture. The remainder of the composition comprised a tin thermal stabilizer at 0.5 to 1.5 weight percent, a lubricant at 1.5 to 3 weight percent, acrylic processing aids at 0.8 to 1.6 weight percent, impact modifiers at 0 to 5 weight percent, titanium dioxide as an ultraviolet light stabilizer at 0.1 to 8 weight percent, 0.7 micron calcium carbonate filler at 0 to 15 weight percent. Pigments, when used, are employed in negligible quantities.

The high intensity mixer is equipped with a cooler (PLASMEC COMBIMIX HC/200/1000/AC with 200 liter tank capacity high intensity turbomixer TRM200/AC and 1000 liter tank capacity cooler). The components are subjected to high-shear forces generated by the high intensity mixer. The high horsepower input from the high intensity mixer resulted in rapid heating of PVC and nanofiller powder mixture. The clusters of particles are disaggregated and distributed uniformly in the powder mixture during the powder mixing process. After about 4.5 minutes mixing, the powder mixture inside the high intensity mixer reaches 105° C. As soon as the powder mixture in the high intensity mixer reach a set temperature of 105° C., the mixture is automatically discharged into a cooler for cooling below 50° C. prior to storage.

### Example 2

A powder mixture was prepared in accordance with the procedures of Example 1 A CaCO₃ nanofiller with particle sizes within the range of 5 nm to 500 nm was used. Samples were taken from different sample points to test the uniformity of the powder mixture obtained. Properties such as fusion behaviors, color, bulk density, and flow time were measured as indicators of uniformity. The fusion behaviors were measured using a torque rheometer (Brabender PL2200). Color (L, a, b) was measured using a spectrophotometer (HunterLab Spectrophotometer Model LabScan XE), where L, a, b are calculated values from measurements against standard with no units of measurements. “L” is a correlate of lightness and darkness with scales between 0 (black) and 100 (white). “a” represents redness (positive) versus greenness (negative). “b” is positive for yellow colors and negative for blue colors. According to the results summarized in Table 1, a uniformly distributed powder mixture was effectively obtained according to the above powder mixing procedures.

TABLE 1
Uniformity Analysis of the Powder Mixture Distribution

| | Property | | | | | | |
|---|---|---|---|---|---|---|---|
| | Fusion Behavior | | | | | Bulk | Flow |
| | Time | Torque | Color | | | Density | Time |
| | (s) | (mg) | L | A | B | (g/cm³) | (s) |
| Sample#1 | 40 | 2659 | 95.92 | −0.60 | 3.25 | 0.625 | 10.18 |
| Sample#2 | 39 | 2700 | 95.89 | −0.60 | 3.20 | 0.623 | 10.20 |
| Sample#3 | 42 | 2623 | 95.85 | −0.59 | 3.23 | 0.626 | 10.21 |
| Sample#4 | 41 | 2688 | 95.95 | −0.58 | 3.29 | 0.628 | 10.19 |
| Sample#5 | 40 | 2692 | 95.87 | −0.59 | 3.27 | 0.627 | 10.22 |

### Example 3

Powder mixtures of PVC nanocomposites for a window profile application were prepared per procedures illustrated in the Example 1. For one nanocomposite (Nanocomposite #1), silica nanofiller with particle sizes within the range of 20 nm to 300 nm was used. For another nanocomposite (Nanocomposite #2), CaCO₃ nanofiller with particle sizes within the range of 5 nm to 500 nm was used. These powder mixtures were then melt processed to form finished products. A conical twin-screw counter-rotating fully intermeshing extruder (25 mm Brabender Extruder) equipped with a 4 inch wide flat sheet die was heated to temperatures sufficient to melt process the powder mixtures. The powder mixtures were extruded at a barrel and die temperature profile of 165° C., 190° C., 190° C., and 190° C. and a screw speed of 35 rpm. Two commercial PVC window profile compounds (Formolon APW05 and Formolon APW01) were also extruded at the same processing conditions.

Extruded sheets were compression molded at 190° C. for 20 minutes into 12″×12″×⅛″ plaques. Tensile and flexural bars were also cut from plaques by a CNC (computer numerical control) machine called Minicutvis made by CEAST USA, a computerized automatic milling instrument for specimen preparation. Tensile and flexural properties were tested according to ASTM D638 and ASTM D790, respectively. The results are listed in Table 2.

TABLE 2
Comparison of Mechanical Properties of PVC Nanocomposite #1 with
Commercial PVC Window Profile Compound #1 (Formolon APW05)

| | Tensile Property | | | Flexural Property | |
|---|---|---|---|---|---|
| | Strength | Modulus | Elongation | Strength | Modulus |
| | (psi) | (psi) | (percent) | (psi) | (psi) |
| PVC Nanocomposite #1 | 7567 | 658,181 | 3.6 | 12,528 | 514,289 |
| PVC WP Compound | 7145 | 592,434 | 3.1 | 11,335 | 415,349 |

According to the results summarized in Table 2, PVC nanocomposites had superior tensile strength, tensile modulus, elongation, flexural strength, and flexural modulus to those exhibited by commercial PVC window profile compound.

Extruded sheets were also cut into 3″×6″ plaques and put into QUV Accelerated Weathering Tester (Model QUV/spray made by Q-Panel Lab Products) for laboratory accelerated weathering test with UVA-340 according to ASTM G53-96. UVA-340 simulated sunlight in the critical short wavelength UV region between 365 nm and the solar cut-off of 295 nm with its peak emission at 340 nm. The QUV test conditions were 8 hours of UV at 60° C. followed by 4 hours of condensation at 50° C. The color values were recorded every 120 hours. The results are listed in Table 3 and Table 4.

TABLE 3
Comparison of Weatherability (QUV) of PVC Nanocomposite #1 with
Commercial PVC Window Profile Compound #1 (Formolon APW05)

| QUV | PVC Nanocomposite #1 | | | | Commercial PVC WP Compound #1 | | | |
|---|---|---|---|---|---|---|---|---|
| Hours | Delta L | Delta a | Delta b | Delta E | Delta L | Delta a | Delta b | Delta E |
| 120 | −0.79 | 0.42 | 2.31 | 2.48 | −0.42 | 0.51 | 1.56 | 1.69 |
| 240 | −1.22 | 0.48 | 3.98 | 4.19 | −0.87 | 0.53 | 3.82 | 3.96 |
| 360 | −1.37 | 0.54 | 4.42 | 4.66 | −1.04 | 0.57 | 4.53 | 4.68 |
| 480 | −1.16 | 0.56 | 3.97 | 4.17 | −0.91 | 0.55 | 4.49 | 4.62 |
| 600 | −1.19 | 0.69 | 3.56 | 3.82 | −1.11 | 0.72 | 4.53 | 4.72 |
| 720 | −1.09 | 0.80 | 3.20 | 3.48 | −1.11 | 0.94 | 4.10 | 4.35 |
| 840 | −0.91 | 0.83 | 2.48 | 2.77 | −0.88 | 0.89 | 3.30 | 3.52 |
| 960 | −1.03 | 0.93 | 2.71 | 3.05 | −0.89 | 0.97 | 3.44 | 3.69 |
| 1080 | −1.05 | 0.94 | 2.81 | 3.14 | −0.97 | 0.95 | 3.64 | 3.89 |
| 1200 | −1.02 | 0.96 | 2.63 | 2.98 | −1.13 | 1.09 | 3.92 | 4.22 |
| 1320 | −1.05 | 0.95 | 2.74 | 3.09 | −1.11 | 1.11 | 3.69 | 4.01 |
| 1440 | −1.19 | 0.91 | 3.36 | 3.68 | −1.21 | 1.16 | 4.25 | 4.57 |
| 1560 | −1.36 | 0.87 | 3.94 | 4.25 | −1.23 | 1.12 | 4.37 | 4.67 |
| 1680 | −1.49 | 0.82 | 4.59 | 4.90 | −1.60 | 1.16 | 5.37 | 5.72 |
| 1800 | −1.62 | 0.85 | 4.19 | 4.57 | −1.77 | 1.07 | 5.35 | 5.74 |
| 1920 | −1.39 | 0.92 | 4.00 | 4.33 | −1.34 | 1.07 | 5.02 | 5.31 |
| 2040 | −1.35 | 0.90 | 3.90 | 4.23 | −1.59 | 1.02 | 5.73 | 6.04 |
| 2160 | −1.39 | 1.07 | 3.72 | 4.11 | −1.52 | 1.03 | 5.36 | 5.67 |
| 2280 | −1.40 | 0.99 | 3.70 | 4.07 | −1.54 | 1.05 | 5.42 | 5.73 |

TABLE 4
Comparison of Weatherability (QUV) of PVC Nanocomposite #2 with
Commercial PVC Window Profile Compound #2 (Formolon APW01)

| QUV | PVC Nanocomposite #2 | | | | Commercial PVC WP Compound #2 | | | |
|---|---|---|---|---|---|---|---|---|
| Hours | Delta L | Delta a | Delta b | Delta E | Delta L | Delta a | Delta b | Delta E |
| 120 | −0.41 | 0.78 | −0.01 | 0.88 | −0.33 | 0.56 | 0.37 | 0.74 |
| 240 | −0.19 | 0.77 | −0.75 | 1.09 | −0.82 | 0.53 | 2.24 | 2.45 |
| 360 | −1.22 | 0.86 | 2.92 | 3.28 | −1.22 | 0.63 | 3.73 | 3.97 |
| 480 | −1.30 | 0.81 | 3.49 | 3.81 | −1.15 | 0.60 | 3.74 | 3.96 |
| 600 | −1.12 | 0.85 | 2.84 | 3.17 | −1.19 | 0.67 | 3.70 | 3.95 |
| 720 | −1.14 | 1.02 | 2.45 | 2.89 | −1.15 | 0.78 | 3.17 | 3.46 |
| 840 | −1.04 | 1.03 | 1.96 | 2.44 | −1.18 | 0.86 | 3.04 | 3.37 |
| 960 | −0.91 | 1.11 | 1.66 | 2.19 | −1.05 | 0.89 | 2.71 | 3.04 |
| 1080 | −0.84 | 1.20 | 1.09 | 1.82 | −1.19 | 0.93 | 3.19 | 3.53 |
| 1200 | −0.96 | 1.24 | 1.28 | 2.03 | −1.16 | 0.94 | 2.90 | 3.26 |
| 1320 | −1.05 | 1.31 | 1.23 | 2.07 | −1.05 | 0.97 | 2.61 | 2.97 |
| 1440 | −0.90 | 1.23 | 1.29 | 2.00 | −1.05 | 0.98 | 2.78 | 3.13 |
| 1560 | −0.88 | 1.26 | 0.97 | 1.82 | −1.27 | 1.02 | 3.16 | 3.56 |
| 1680 | −0.97 | 1.26 | 1.05 | 1.90 | −1.28 | 0.91 | 3.43 | 3.78 |
| 1800 | −1.90 | 1.30 | 1.65 | 2.83 | −2.28 | 1.02 | 4.36 | 5.02 |
| 1920 | −1.13 | 1.18 | 2.07 | 2.64 | −1.40 | 0.89 | 4.26 | 4.57 |
| 2040 | −1.31 | 1.08 | 2.91 | 3.37 | −1.57 | 0.91 | 4.48 | 4.83 |
| 2160 | −1.38 | 1.10 | 3.09 | 3.56 | −1.88 | 0.95 | 5.09 | 5.51 |
| 2280 | −1.36 | 1.17 | 2.67 | 3.22 | −1.68 | 0.96 | 4.55 | 4.94 |

According to the weathering results illustrated in Table 3 and Table 4, PVC nanocomposites had much better weatherability than commercial PVC window profile compounds. The improved weatherability enables PVC nanocomposites in the applications of window profile, fencing, decking, railing, and the like to be used in the high UV area such as Southwest region of the United States, where conventional PVC window profile compounds commonly fail. It also allows PVC nanocomposites produced by simple extrusion to replace the more expensive acrylic cap stocks over the conventional PVC compounds produced by a more complicated co-extrusion process. Huge cost reduction from both material and processing may be realized commercially.

### Example 4

Powder mixture of PVC nanocomposite for a substrate application was prepared in accordance with the procedures of Example 1. CaCO₃ nanofiller with particle sizes within the range of 5 nm to 500 nm was used. The dry blend thus obtained was extruded into sheets according to the conditions of Example 3. A commercial PVC siding substrate compound (Formolon AWS04) was also extruded at the same processing conditions. The extruded sheets were compression molded at 190° C. for 20 minutes into 12″×12″×⅛″ plaques. HDT and notched Izod bars were produced from the plaques by a CNC machine called Minicutvis. HDT and notched Izod impact tests were performed according to ASTM D648 and ASTM D256, respectively. In this case, the potential application is for the board of delivery truck, which has stringent requirements for both high HDT and high impact. Normally high HDT and high impact strength are not achievable at the same time such as in this case because HDT and impact fight against each other. Current commercial PVC siding substrate compounds failed the test. It was considered to use more expensive engineering plastics for this application.

PVC nanocomposite may be used in this application to replace more expensive engineering plastics. Table 5 lists HDT and Izod impact test results of PVC nanocomposite and commercial PVC substrate compound. The results demonstrate that PVC nanocomposite had much higher HDT and notched Izod impact than commercial PVC siding substrate compound.

TABLE 5
Comparison of HDT and Izod Impact properties
of PVC Nanocomposite with Commercial PVC Siding
Substrate Compound (Formolon AWS04)

| | HDT (° C.) | Izod Impact (ft-lb/in) |
|---|---|---|
| PVC Nanocomposite | 77.5 | 22.97 |
| PVC Substrate Compound | 74.9 | 3.665 |

### Example 5

The powder mixture of PVC nanocomposite for a window profile application was prepared according to the procedure described in the Example 1. Silica nanofiller with particle sizes within the range of 20 nm to 300 nm was used. A commercial scale extrusion line was used. The powder mixture of PVC nanocomposite was dropped in right behind a commercial PVC window profile compound with the same processing conditions on two commercial extrusion lines. Line #1 has a Davis Standard (DS Gemini GC65, conical twin-screw) extruder equipped with a mainframe die. Line #2 has a Krauss Maffei (MD 2-60 KK, parallel, twin-screw) extruder equipped with a frame profile die. The extruder temperature profile was very typical and in the range of 180° C. (356° F.) to 195° C. (383° F.). Transition was very smooth on both lines. Both lines made good parts from PVC nanocomposites, which passed all lab tests. Although Line #2 without nanofiller present had difficulty in running this particular commercial PVC window profile compound, it produced acceptable parts from PVC nanocomposite without any problems. Line #1 continued to run for several days without interruption and produced very good parts. Results were compiled in the Table 6.

TABLE 6
Comparison of PVC Nanocomposite and Commercial
PVC Window Profile Compound (Formolon APW05) Processed
on Commercial Scale Extrusion Lines

| | | PVC WP |
|---|---|---|
| Property | PVC Nanocomposite | Compound |
| Processing Latitude | Wider than PVC Compound | Fair |
| Sizing Property | Easier than PVC Compound | Good |
| Resistance to Plate Out | Better than PVC Compound | Fair |
| Extrusion Output | 2.34 m/min | 2.08 m/min |
| Color | Pass | Pass |
| Gloss | Pass | Pass |
| Part Dimension | Pass | Pass |
| Part Weight | Pass | Pass |
| Part Shrinkage | 0.9 percent | 1.6 percent |
| Drop Dart Impact Strength | Better than PVC Compound | Good |

According to the results presented in Table 6, PVC nanocomposite had wider processing window, better resistance to plate out, higher throughput, less part shrinkage, and better drop dart impact strength than commercial PVC window profile compound. Overall the PVC nanocomposite had much better performance to cost ratio than commercial PVC window profile compound.

This process provides a cost effective way to process the PVC nanocomposites into finish products with lower cost and better performance. Applications of the PVC nanocomposites include, but are not limited to, rigid PVC applications such as pipe and fittings, siding, window, door, fencing, decking, railing, sheet, outdoor furniture, other profile, conduit, duct, raceways for electrical, electronic, and communications, receptacle, and the like, as well as in flexible PVC applications such as wire and cable, cosmetics packaging, container, hose, tubing, and the like. The nanocomposites formed using the methodology and technology in this invention have significantly improved properties such as stiffness, toughness, heat deflection or distortion temperature (HDT), part shrinkage, dimensional stability, UV resistance, weatherability, fire resistance, heat stability, etc. The nanocomposite mixtures displays greater processing latitude, easier process startup, longer equipment run time, higher throughput, etc. The methodology and technology of this invention can be easily transferable to other polymer/nanofiller nanocomposite systems. Finish products using the nanocomposites have better weatherability, tensile strength, tensile modulus, elongation, flexural strength, flexural modulus, heat distortion temperature, and impact strength than commercial PVC compounds. The melt processing characteristics of the nanocomposites have better processing latitude, easier sizing property, higher resistance to die plate-out, higher extrusion output rate, and less finish part shrinkage than commercial PVC compounds.

Some properties of nanocomposites, for example, improved strength with lightweight properties, increased gloss, improved clarity, antibacterial when silver nanoparticles are present, self-cleaning when TiO₂ nanoparticles are present, higher production rates, improved barrier, enhanced scratch resistance, better fire resistance, better dimensional stability, improved heat distortion temperatures, improved thermal stability, improved weatherability, and lower coefficient of thermal expansion, and cannot be duplicated by conventional filler filled resin at any loading. All these attributes may be achieved because the homogeneous dispersion of nanoparticles on the nanometer scale is obtained for maximum interaction at the interface between the two dissimilar materials.

The technology and methodology of the invention provides a cost effective means for producing nanocomposite from polymer (specifically PVC) and nanofillers for the purpose of enhancing physical properties, heat deflection temperature (HDT), weatherability, processability, stiffness and rigidity, finish product dimensional stability, etc. Again the technology used in this invention applies to other polymers and nano-scale materials.

The technology used in this invention provides a cost effective way to synthesize nanocomposites that enhance the properties of a wide range of commodity and engineering thermoplastics and thermosets. This invention utilizes rheological techniques to create polymer/nanofiller nanocomposites with a variety of improved properties. The technology can be applied to PVC, CPVC, and other polymers as described previously. This technology can be commercialized with huge economical value. It has the broad commercial viability due to its performance to cost profile.

This invention has benefits in expanding the markets for the specific polymer or at least improving the performance to cost profile within the specific polymer type. This invention has the applications in packaging, automotive components, appliances, electrical parts, electronic parts, and building and construction products. This invention has great potential to speed market penetration of PVC-based nanocomposites into building and construction such as pipe, siding, window, door, fencing, decking and the like, automotive, appliance, wire/cable, and other durable-goods markets by providing PVC nanocomposite materials with better processing performance, enhanced material performance and cost advantages.

The present invention allows the manufacture of products from PVC nanocomposites not only with properties much superior to that of the corresponding unfilled and conventionally-filled PVC compounds, but also with much lower cost than conventional PVC compounds. In addition, the present invention offers better processing latitude and higher output rate for a variety of commercial applications. PVC nanocomposites produced based on the present invention have the tremendous potential to replace conventional PVC compounds at a much less cost for a variety of commercial products. Products that may be manufactured from the present invention include pipe, siding, fencing, decking, railing, window profile, sheet, construction board, film, packaging, wire and cable, flooring, injection molded articles, bottles, records, and the like. What is more, the methodology and technology of this invention are fully applicable to other polymer/nanofiller nanocomposite systems prepared by melt processing.

What is claimed is:

1. A method for forming a polymer nanocomposite, comprising:
powder mixing a composition comprising polymer resin, a nanofiller, and a coupling agent for a residence time of about 4 to about 8 minutes to form a dry blend; and
extruding the dry blend in an extrusion process.

2. The method of claim 1, wherein the powder mixing occurs at a temperature of less than about 115° C.

3. The method of claim 1, wherein the maximum temperature during powder mixing is about 100° C. to about 115° C.

4. The method of claim 1, wherein the residence time is about 4 to about 6 minutes.

5. The method of claim 1, wherein the extrusion process occurs at a barrel and die temperature of about 180° C. to about 195° C.

6. The method of claim 1, further comprising exposing the dry blend to an independent metering feeder to feed the dry blend into an extruder.

7. The method of claim 1, wherein the dry blend is extruded in a twin-screw extruder.

8. The method of claim 7, wherein the dry blend is extruded with a barrel and screw temperature of about 0° C. to about 20° C. cooler than an extrusion process with no nanofiller present.

9. The method of claim 1, wherein the polymer resin comprises a polymer selected from the group consisting of polyvinyl chloride (PVC), chlorinated polyvinyl chloride (CPVC), acrylics, acrylonitrile-butadiene-styrene copolymer (ABS), acrylonitrile-styrene-acrylate (ASA), aliphatic polyketone, alkyd resins, elastomers, thermoplastic olefinic elastomer (TPO), epoxy resins, ethylene vinyl acetate copolymer (EVA), ethylene-ethyl acetate copolymer (EEA), ethylene-propylene copolymers (EPR & EPDM), ionomers, liquid crystalline polymers (LCP), perfluoroalkoxy resin (PFA), phenolic resins, poly(acrylic acid) (PAA), polyamides (PA), polyamideimide (PAI), polyamines, polyaniline (PANI), polyaryletherketone (PAEK), poly(butylenes terephthalate) (PBT), polycarbonate (PC), polyetheretherketone (PEEK), polyetherimide (PEI), polyether sulfone (PES), polyethylene (PE), chlorinated polyethylene (CPE), chlorosulfonated polyethylene (CSM), poly(ethylene oxide) (PEO & PEG), poly(ethylene terephthalate) (PET), polyimide (PI), polymethylmethacrylate (PMMA), polyoxymethylene (POM), poly(phenylene ether) (PPO), poly(phenylene sulfide) (PPS), polypropylene (PP), polypyrrole, polystyrene & high impact (PS & HIPS), polysulfides, polysulfone (PSO), polytetrafluoroethylene (PTFE), polyurethanes (PU & TPU), poly(vinyl acetate) (PVAc), poly(vinyl alcohol) (PVAl), poly(vinyl butyral) (PVB), rubbers such as natural rubber (NR), nitrile rubber (NBR), polybutadiene rubber (BR), polybutyl rubber (HR), polychloroprene (CR), polyisobutylene (PIB), polyisoprene (IR), and styrene-butadiene rubber (SBR), silicones (SI), styrene-acrylonitrile copolymer (SAN), tetrafluoroethylene-perfluoropropylene (FEP), unsaturated polyesters, vinylidene-fluoride terpolymers (PVDF), derivatives thereof, and combinations thereof.

10. The method of claim 1, wherein the polymer resin comprises polyvinyl chloride.

11. The method of claim 1, wherein the nanofiller comprises a component selected from the group consisting of boehmite alumina (synthetic) nanofillers, aluminorganic nanofillers, calcium carbonate nanofillers, ceramic nanofillers, carbon black nanofillers, carbon nanotube nanofillers, cellulose nanofillers, activated clay nanofillers, natural clay nanofillers (mined, refined, and treated), clay (synthetic) nanofillers, organo clay nanofillers, natural fiber nanofillers, gold nanofillers, graphite nanofillers, hydrotalcite nanofillers, kaolin nanofillers, magnesium hydroxide nanofillers, mica nanofillers, mineral nanofillers, montmorillonite clay nanofillers, phosphate nanofillers, Poly oligomeric silsesquioxane (POSS) nanofillers, silica nanofillers, silver nanofillers, talc nanofillers, antimony pentoxide nanofillers, organo-titanate nanofillers, titanium white nanofillers, Wollastonite nanofillers, zeolite nanofillers, zinc oxide nanofillers, organo-zirconate nanofillers, zirconia nanofillers, alumina trihydrate (ATH), and combinations thereof.

12. The method of claim 1, wherein the nanofiller has a mean particle size of about 1 nm to 1000 nm.

13. The method of claim 1, wherein the nanofiller has a mean particle size of about 5 nm to about 500 nm.

14. The method of claim 1, wherein the nanofiller has a mean particle size of about 20 nm to about 300 nm.

15. The method of claim 1, wherein the nanofiller comprises particles having an irregular or spherical shape.

16. The method of claim 1, wherein the nanofiller comprises particles having an aspect ratio less than or equal to 500:1.

17. The method of claim 1, wherein the nanofiller is from 0.1 to 20 weight percentage of the composition.

18. The method of claim 1, wherein the nanofiller is surface treated.

19. The method of claim 1, wherein the nanofiller is not surface treated.

20. The method of claim 1, wherein the coupling agent is fatty acid, fatty acid derivative, silane, titanate, zirconate, aluminate, surfactant, plasticizer, resin with a melting point lower than PVC, or combinations thereof.

21. The method of claim 1, wherein the coupling agent is stearic acid, hydrogenerated fatty acid, ester of fatty acids and fatty alcohols, partial fatty acid ester of glycerine, metal carboxylate, 3-aminopropyl trimethoxy silane, titanium IV 2,2(bis 2-propenolatomrthyl)butanolato, tris(dioctyl)pyrophosphato-O, zirconium IV 2-ethyl, 2-propenolatomethyl 1,3-propanediolato, cyclo di 2,2-(bis 2-propenolatomethyl)butanolato pyprophosphato-O,O, epoxidized soybean oil, diisodecyl phthalate, oxidized polyethylene, chlorinated polyethylene, or combinations thereof.

22. The method of claim 1, wherein the dry blend further comprises thermal stabilizers, plasticizers, lubricants, processing aids, impact modifiers, antioxidants, ultraviolet light stabilizers, hindered amine light stabilizers, fillers, pigments, or combinations thereof.

23. A polymer nanocomposite formed by a process, comprising:
powder mixing a composition comprising a polymer resin, a nanofiller, and a coupling agent for a residence time of about 4 to about 8 minutes to form a dry blend; and
extruding the dry blend in an extrusion process.

24. The polymer nanocomposite of claim 23, wherein the distribution of nanofiller is more homogeneous than if the composition is powder mixed for a residence time of less than about 4 minutes.

25. The polymer nanocomposite of claim 23, wherein the extruding the dry blend is performed using an extruder at an output rate of 0 to 20 percentage higher than an extrusion process with no nanofiller present.

26. The polymer nanocomposite of claim 23, wherein the polymer resin comprises a polymer selected from the group consisting of polyvinyl chloride (PVC), chlorinated polyvinyl chloride (CPVC), acrylics, acrylonitrile-butadiene-styrene copolymer (ABS), acrylonitrile-styrene-acrylate (ASA), aliphatic polyketone, alkyd resins, elastomers, thermoplastic olefinic elastomer (TPO), epoxy resins, ethylene vinyl acetate copolymer (EVA), ethylene-ethyl acetate copolymer (EEA), ethylene-propylene copolymers (EPR & EPDM), ionomers, liquid crystalline polymers (LCP), perfluoroalkoxy resin (PFA), phenolic resins, poly(acrylic acid) (PAA), polyamides (PA), polyamideimide (PAI), polyamines, polyaniline (PANI), polyaryletherketone (PAEK), poly(butylenes terephthalate) (PBT), polycarbonate (PC), polyetheretherketone (PEEK), polyetherimide (PEI), polyether sulfone (PES), polyethylene (PE), chlorinated polyethylene (CPE), chlorosulfonated polyethylene (CSM), poly(ethylene oxide) (PEO & PEG), poly(ethylene terephthalate) (PET), polyimide (PI), polymethylmethacrylate (PMMA), polyoxymethylene (POM), poly(phenylene ether) (PPO), poly(phenylene sulfide) (PPS), polypropylene (PP), polypyrrole, polystyrene & high impact (PS & HIPS), polysulfides, polysulfone (PSO), polytetrafluoroethylene (PTFE), polyurethanes (PU & TPU), poly(vinyl acetate) (PVAc), poly(vinyl alcohol) (PVAl), poly(vinyl butyral) (PVB), rubbers such as natural rubber (NR), nitrile rubber (NBR), polybutadiene rubber (BR), polybutyl rubber (HR), polychloroprene (CR), polyisobutylene (PIB), polyisoprene (IR), and styrene-butadiene rubber (SBR), silicones (SI), styrene-acrylonitrile copolymer (SAN), tetrafluoroethylene-perfluoropropylene (FEP), unsaturated polyesters, vinylidene-fluoride terpolymers (PVDF), derivatives thereof, and combinations thereof.

27. The polymer nanocomposite of claim 23, wherein the polymer resin comprises polyvinyl chloride.

28. The polymer nanocomposite of claim 23, wherein the nanofiller comprises a component selected from the group consisting of boehmite alumina (synthetic) nanofillers, aluminorganic nanofillers, calcium carbonate nanofillers, ceramic nanofillers, carbon black nanofillers, carbon nanotube nanofillers, cellulose nanofillers, activated clay nanofillers, natural clay nanofillers (mined, refined, and treated), clay (synthetic) nanofillers, organo clay nanofillers, natural fiber nanofillers, gold nanofillers, graphite nanofillers, hydrotalcite nanofillers, kaolin nanofillers, magnesium hydroxide nanofillers, mica nanofillers, mineral nanofillers, montmorillonite clay nanofillers, phosphate nanofillers, Poly oligomeric silsesquioxane (POSS) nanofillers, silica nanofillers, silver nanofillers, talc nanofillers, antimony pentoxide nanofillers, organo-titanate nanofillers, titanium white nanofillers, Wollastonite nanofillers, zeolite nanofillers, zinc oxide nanofillers, organo-zirconate nanofillers, zirconia nanofillers, alumina trihydrate (ATH), and combinations thereof.

29. The polymer nanocomposite of claim 23, wherein the nanofiller has a mean particle size of about 1 nm to 1000 nm.

30. The polymer nanocomposite of claim 23, wherein the nanofiller has a mean particle size of about 5 nm to about 500 nm.

31. The polymer nanocomposite of claim 23, wherein the nanofiller has a mean particle size of about 20 nm to about 300 nm.

32. The polymer nanocomposite of claim 23, wherein the nanofiller comprises particles having an irregular or spherical shape.

33. The polymer nanocomposite of claim 23, wherein the nanofiller comprises particles having an aspect ratio less than or equal to 500:1.

34. The polymer nanocomposite of claim 23, wherein the nanofiller is from 0.1 to 20 weight percentage of the composition.

35. The polymer nanocomposite of claim 23, wherein the coupling agent is fatty acid, fatty acid derivative, silane, titanate, zirconate, aluminate, surfactant, plasticizer, resin with a melting point lower than PVC, or combinations thereof.

36. The polymer nanocomposite of claim 23, wherein the coupling agent is stearic acid, hydrogenerated fatty acid, ester of fatty acids and fatty alcohols, partial fatty acid ester of glycerine, metal carboxylate, 3-aminopropyl trimethoxy silane, titanium IV 2,2(bis 2-propenolatomrthyl)butanolato, tris(dioctyl)pyrophosphato-O, zirconium IV 2-ethyl, 2-propenolatomethyl 1,3-propanediolato, cyclo di 2,2-(bis 2-propenolatomethyl)butanolato pyprophosphato-O,O, epoxidized soybean oil, diisodecyl phthalate, oxidized polyethylene, chlorinated polyethylene, or combinations thereof.

37. The polymer nanocomposite of claim 23, wherein the composition further comprises thermal stabilizers, plasticizers, lubricants, processing aids, impact modifiers, antioxidants, ultraviolet light stabilizers, hindered amine light stabilizers, fillers, pigments, or combinations thereof.

38. The polymer nanocomposite of claim 23, wherein the nanocomposite has improved performance as compared to a PVC composite with no nanofiller present with respect to one or more of weatherability, tensile strength, tensile modulus, elongation, flexural strength, flexural modulus, heat distortion temperature, and impact strength.

39. The polymer nanocomposite of claim 23, wherein the nanocomposite has improved performance as compared to a PVC composite with no nanofiller present with respect to one or more of processing latitude, easier sizing property, higher resistance to die plate-out, higher extrusion output rate, and less finish part shrinkage.

40. The polymer nanocomposite of claim 23, further comprising using the polymer nanocomposite for pipe and fittings, siding, window profile, door profile, fencing, decking, railing, sheet, outdoor furniture, construction board, conduit, duct, raceways for electrical, electronic, and communications, receptacle, and other rigid PVC applications.
